(19) United States
(12) Patent Application Publication
(10) Pub. No.: US 2002/0068480 A1
(43) Pub. Date: Jun. 6, 2002

(54) ELECTRICAL CONNECTOR PLUG FOR IGNITION DEVICES

(76) Inventors: MATTHIAS PFAFF, OFFENBACH (DE); KLAUS RIEGER, IGENSDORF (DE)

Correspondence Address: CLARENCE A GREEN, PERMAN & GREEN LLP, 425 POST ROAD, FAIRFIELD, CT, 06430

(21) Appl. No.: 09/434,612

(22) Filed: Nov. 5, 1999

(30) Foreign Application Priority Data
Nov. 6, 1998 (DE) DE 19851301

(51) Int. Cl. H01R 13/648

(52) U.S. Cl. 439/607

(57) ABSTRACT

The invention concerns an electrical plug connector with a shielding device (8) which comprises a housing (1) and a plug-in projection (2) mold onto the housing (1) which comprises along the plugging-in direction of the plug connector, contact elements (5) for engaging with corresponding counterparts (32) in a connector part (30) and at least one guide element (7) for engaging with a complementary piece (31), where the shielding device (8) comprises an electrically conductive ring (10) which surrounds the contact elements (5) and contact studs (11) for conducting away electrical charges on the connector part (30).

The present invention is relating to an electrical connector plug for ignition devices designed according to the teaching of the preamble of the first claim. Such plugs find particular application for airbag restraint systems in motor vehicles.

There, the plug connector with its plug-in projection is plugged onto a corresponding counterpart which is located on the housing of the ignition device of the airbag. The ignition device, the impact bag as well as the electrical leads are located on the driver's side in the impact plate of the steering wheel. Furthermore, the electrical connection of the ignition device forms, together with the control system, a very sensitive place of the restraint system, since uncontrolled potential fluctuations which occur on the electrodes of the ignition device may lead to an unscheduled release of the airbag.

The U.S. Pat. No. 4,306,499, describes a plug connector with non-massed junctions. In order to provide a shield from electrostatic energy, an ignition initiator is fitted with a shield socket which surrounds an ignition unit, so that electrostatic energy received from the socket which is connected to the ignition unit is passed to the shield socket via a spark discharge. This prevents an uncontrolled triggering of the ignition device via electrostatic energy

This construction has the drawback that the ignition distance between the two sockets of the ignition device must be very carefully adhered to, which makes this the requirement placed on the process of manufacture of the two shells a very stringent one and this fact, in turn, is responsible for a very high cost of the ignition device as a whole. Furthermore, neither the electrical junctions of the ignition device, nor the electrical junctions of the plug connector are protected in any way. Thus, the ignition device or the plug connector can be electrostatically charged so that during the process of plugging in the electrostatic energy is sufficient to trigger the ignition device.

For this reason, known plug connectors have plug-in pins in their plug-in sockets which are plugged onto plug pins and the plug-in projection separates a shorting bar between the plug pins of the ignition device from the latter when the contact for the plug-in sockets already exists.

The said shorting bar effectively prevents the unscheduled triggering of the ignition device by electrostatic energy during the process of plugging-in.

The patent EP 0 591 347 describes a plug connector equipped with such a shorting bar which is so constructed that the shorting bar is arranged in an additional restraint.

This construction has the drawback that the plug connector now consists of three parts, to wit, the plug connector itself, the complementary matching plug-in counterpart and the restraint with a shorting bar. This increases costs as well as prolongs the time needed for carrying out the construction.

In both cases, the ignition devices are triggered via a control unit, where the ignition devices exhibit no “intelligence”, that is to say, they do not incorporate any control electronics. Therefore, a current is sent by the electronic control center to the ignition device, causing the latter to ignite.

The plug connectors which are here presented are not suitable for the linking of peripherals such as airbag igniters to the newly introduced bus systems which have recently been introduced into vehicle technology.

The present invention has the goal of connecting the ignition device carrier of the ignition device to mass immediately on being plugged in, even before the electrical pins of the ignition device and the electrical plug-in sockets of the plug connector have made electrical contact. Furthermore, the plug-in part of the plug connector should be protected from acquiring an electrostatic charge or from electromagnetic interference.

This goal is achieved by the characteristics described in the characterizing part of the claims. The subsidiary claims illustrate the preferred embodiments of the invention.

The electrical plug connector fitted with a shielding device may exhibit a housing. Furthermore, a plug-in projection may be provided on the housing, which may exhibit cells distributed along the plug-in direction of the plug connector, in which contact elements may be located. On the side of the plug-in projection can be arranged at least one stop spring element which may also be a stop spring arm, for clicking into at least one retainer provided in a corresponding connector part which is complementary to the plug-in projection. Further, a guide element for sliding into a complementary piece may be provided. Apart from this, the connector plug may exhibit a cover which matches the housing. The shielding device may have an electrically conducting ring connected to mass which surrounds the contact elements which exhibit contact studs distributed around the plug-in projection.

In the case of the said electrical connector plug, the fact that the shielding device surrounds the insertion projection like a Faraday cage and is integrated in the connector plug is particularly advantageous. It is a special feature of the shielding device that it is arranged on the plug-in projection in such a way that on being plugged into a metal ignition device carrier, the latter is automatically earthed.

Various embodiments of the invention will now be more fully illustrated schematically by means of drawings. The figures which follow show the following aspects of the invention.

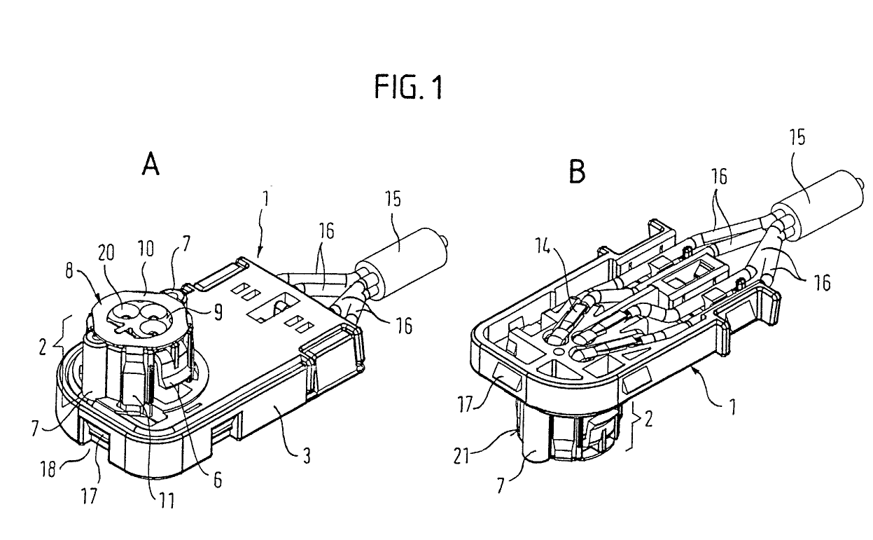

FIG. 1A shows a plug connector according to the invention looking diagonally at the plug-in projection

FIG. 1B shows a plug connector according to the invention without its cover looked at diagonally, where the plug connector from FIG. 1A has been rotated through 180° along its longitudinal axis.

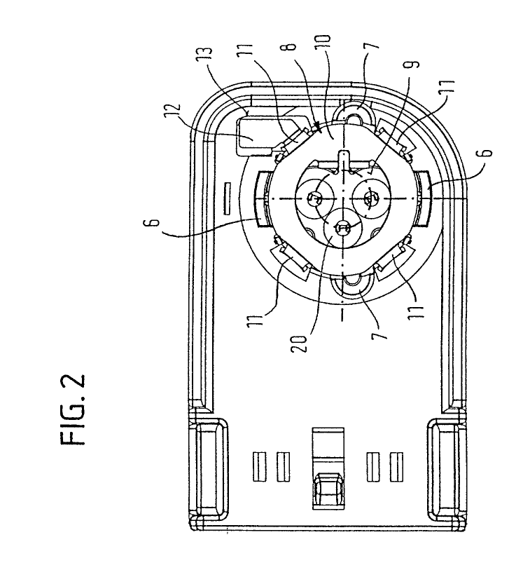

FIG. 2 shows a plan view of the plug connector according to the invention;

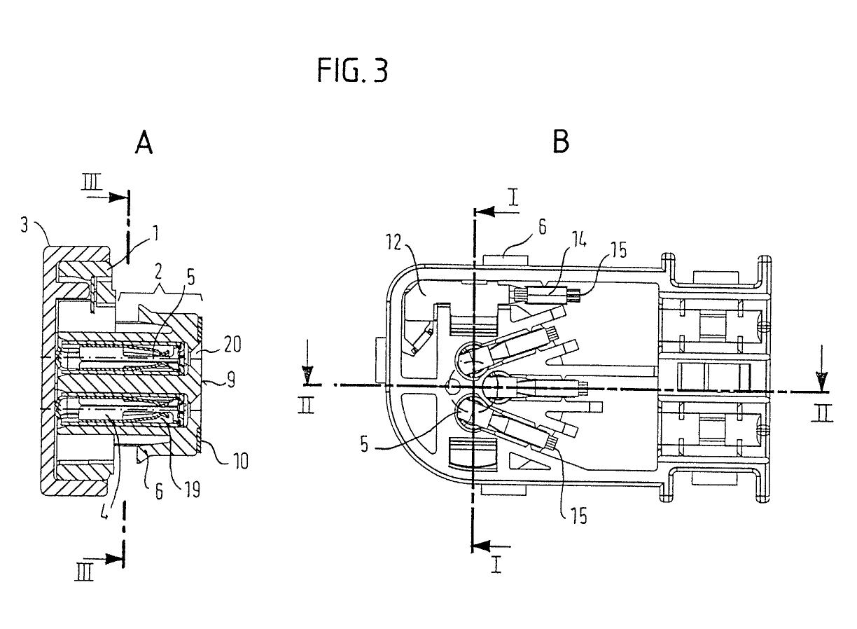

FIG. 3B shows a view of the reverse side of the opened-up plug connector

FIG. 3A shows a section along the line I-I of FIG. 3B and

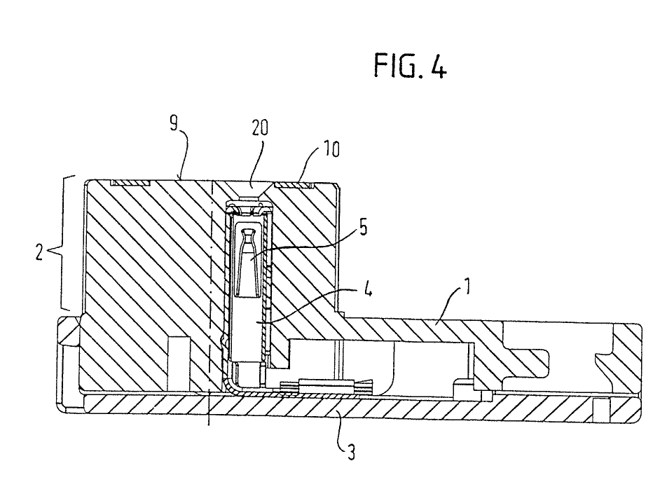

FIG. 4 shows a section along the line II-II of FIG. 3B

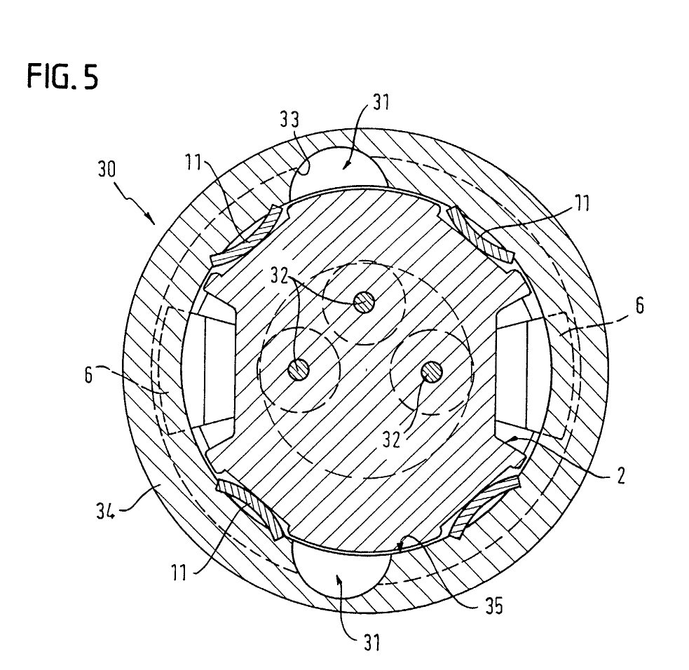

FIG. 5 is a highly schematic section of the plugged-in plug connector along the line III-III of FIG. 3A

In FIGS. 1A and 1B, the plug connector according to the invention is seen both with and without its cover 3. The plug connector comprises a housing, a plug-in projection 2 and a cover 3. The housing is fitted with a stop keys 17 which are able to reach into the openings 18 of the cover 3 when they are interconnected, as shown in FIG. 1A. The plug-in projection 2 is substantially cylindrical in shape. The form of the plug-in projection can be elliptical, rectangular or square and the edges of the plug-in projection and the walls of the connector part assume the task of the guide element 7.

On the cylinder jacket of the plug-in projection 2 there are two guide elements 7 which are mold over the entire height of the plug-in projection 2. These guide elements 7 are also employed as coding keys, in order to forestall any confusion as between similar plug connectors. Similar plug connectors are identical, except for the arrangement of the guide elements 7. Also on the cylinder jacket 21 are mold-on in diametrically opposed positions two elastic stop spring arms. These are able to snap into retainers which are provided in a connector part which is complementary to the plug-in projection. An ignition device carrier (see FIG. 5) of an airbag ignition device may be regarded as being one of the connector parts. The closing surface 9 of the plug-in projection 2 comprises passages 20 to the cells 4 and also the ring 10 of the shielding device 8 which surrounds the passages 20 to the cells 4. On this ring 10 are mold contact studs which are arranged along the plug-in projection 2. The central points of the vaults are external to the plug-in projection 2.

In FIG. 1B, the cabling of the plug connector can clearly be seen. One the one hand, the plug connector has 3 junctions which lead to a system bus and on the other hand an mass which is connected to the vehicle mass. This mass is electrically connected to the shield 8.

FIG. 2 shows a plan view of the plug connector, where the connection of the shield 8 can be clearly be seen. One of the said contact studs 11 of the shied 8 is extended by means of a contact element 12 which passes through one of the openings 13 of the housing 1 and then passes into the housing interior into a crimp connection, to which is crimped a single strand 16 which leads to the vehicle mass. In this figure, the vaults of the contact studs 11 can clearly be seen, with the edges of the contact studs bent away from the plug-in projection.

FIG. 3B shows a plan view of the reverse side of the plug connector. The section along the line I-I (FIG. 3A) is also seen in FIG. 3A. On the right hand side of FIG. 3A can be seen the ring 10 and also, both above and below the plug-in projection 2, the stop spring arms 6. Since the section runs along the plug-in direction of the plug connector and passes through the cells 4, the plug sockets can easily be seen. These exhibit a narrowing 19 in the right hand side area of FIG. 3A; this narrowing enables them to make better contact with the plug-in pins of the ignition device carrier. To make the introduction of the plug connector easier, the passages 20 to the cells 4 are widened in an outward direction.

FIG. 4 shows a section along the line II-II of FIG. 3B. This figure shows particularly clearly how the plug-in socket passes to the crimp connection. To simplify the diagram, the strands of the cable have only been shown partially.

FIG. 5 shows a section of a plugged-in plug connector along the line III-III which is shown in FIG. 3A.

The connector part 30 which can in particular be an ignition device carrier of an airbag ignition device, comprises a conducting housing 34 with slots 31 for the retention of guide elements, a first retainer 31 for engaging the stop spring arms and a second retainer 35 for the plugging-in of a plug-in projection. Further, the floor of the housing 34 comprises contact pins 32 in the direction of insertion, the contact pins being electrically insulated from the housing 34. The second retainer 34 is essentially circular in shape, to match the plug-in projection 2.

The first retainer 33 is fitted into the side wall of the housing 34 in such a way that on the one hand the first retainer 33 covers the entire circumference and on the other hand is open towards the second retainer 34.

The respective distances between the housing floor and the first retainer and the distance between the closing surface 9 and the stop lug 22 are identical. To simplify the diagram, FIG. 5 shows only the plug-in projection 2, the stop spring arms 6 and the contact studs 11. It can be seen particularly clearly, how the contact studs 11 penetrate into the ignition device carrier and how the stop spring arms are in the engaged position.

Hereinafter follows only one embodiment example of the plug connector according to the invention.

This plug connector with a shielding device is employed in particular as a plug connection for bus systems. In contrast to the cited state-of-the-art it must be stated that the actual information concerning the triggering of the ignition device is sent out in a coded form. According to the state-of-the-art, a current impulse is sent by the control system to the plug connector which triggers the ignition device. The “intelligence” of the control system is apportioned, that is to say, the ignition device carrier of the ignition device receives its own logic.

So that the ignition device may be triggered, the control system only needs to send a digital signal with the address of the ignition device via the bus and the logic of the ignition carrier then evaluates the signal and carries out a corresponding procedure in order to ignite the ignition device. The fact that in order to ignite the ignition device a certain coding is required is advantageous so that a signal from interference is generally insufficient to trigger the ignition device. It has transpired that it is advantageous to lead the mass of the vehicle separately from the mass of the bus. This causes one of the junctions of the plug connector to act as the bus mass, whilst the other two represent the entry and exit junctions of the bus.

When the plug connector according to the invention is plugged into its matching conducting ignition carrier, the contact studs 11 of the screen 8 penetrate into the housing 34 of the ignition device carrier. In a fully plugged-in condition, the stop spring arms 6 snap into the slots 3. The making of this contact serves to protect from electrostatic charge which is passed to the vehicle mass. Otherwise, the said electrostatic charges would be carried by the ignition device. Since the contact studs penetrate into the surface of the ignition device carrier, a plugged-in connection is created which it is difficult to break and which cannot easily be loosened by vibrations.

1. An electrical plug connector (8) comprises
a housing (1) and
a plug-in projection (2) mold onto the housing (1) which comprises along the plug-in direction of the plug connector contact elements (5) for interaction with corresponding counter elements (32) in a connector part (30)
characterized in that
a shielding device (8) comprising an electrically conductive ring (10) which surrounds the ends of the contact elements (5) and with at least one connection which is connected to a cable (15) in the plug connector.

2. An electrical plug connector according to claim 1, characterized by the facts that the contact elements (5) are plug sockets which are arranged inside cells (4) in the plug-in projection (2) and the corresponding counterparts are contact pins (32) and that the ring (10) is arranged on the closing surface (9) of the plugin projection (2) in such a way that the passages (20) to the cells (4) are surrounded by the ring (10).

3. An electrical plug connector according to one of the preceding claims, characterized by the fact that the ring comprises contact studs (11) which are arranged parallel to the plugging-in direction.

4. An electrical plug connector according to the preceding claims, characterized by the fact that the ring comprises contact studs (11) which are extended by means of a contact element (12) which passes through the opening (13) of the housing (1) and which is electrically connected by means of a crimp (14) which clamps the cable (15) and which is located inside the plug connector.

5. An electrical plug connector according to one of the preceding claims, characterized by the fact that the contact studs (11) are convex towards the plug-in projection (2) and become broader in the direction of the housing (1), so that the sharp edges of the contact studs (11) penetrate into the complementary metal connector part (30).

6. An electrical plug connector according to one of the preceding claims, characterized by the fact that the shielding device (8) comprises bent hooks in the direction of the plug-in projection (2) so that they penetrate into the plug-in projection (2) and hold the shielding device (8) in place.

7. An electrical plug connector according to one of the preceding claims, characterized by the fact that the housing (1) and the cover (3) exhibit matching stop elements making the housing and the cover able to be plugged in.

8. An electrical plug connector according to one of the preceding claims, characterized by the fact that the plug-in projection (2) is substantially cylindrical in shape and at least one stop spring arm (6) and one guide element (7) are arranged on the outer circumference of the plug-in projection (2).

9. An electrical plug connector according to one of the preceding claims, characterized by the fact that the shielding device (8) is on the vehicle mass.

10. An electrical plug connector according to one of the preceding claims, characterized by the fact that the plug connector is a plug connector for airbags.
